(19) United States
(12) Patent Application Publication
(10) Pub. No.: US 2019/0362393 A1
(43) Pub. Date: Nov. 28, 2019

(54) ADVANCED DIGITAL MARKETING METHOD, APPARATUS AND SYSTEM

(71) Applicant: Herofi, Inc., San Diego, CA (US)

(72) Inventors: Vladimir Edelman, Carlsbad, CA (US); Trent Dethloff, San Diego, CA (US)

(21) Appl. No.: 16/424,372

(22) Filed: May 28, 2019

Related U.S. Application Data
(60) Provisional application No. 62/676,310, filed on May 25, 2018.
(60) Provisional application No. 62/807,294, filed on Feb. 19, 2019.

(51) Int. Cl. G06Q 30/02

(52) U.S. Cl. CPC G06Q 30/0276; G06Q 30/0201; G06Q 30/0277

(57) ABSTRACT

An advanced digital marketing system, apparatus and method is described. A server retrieves publicly-available online information related to a merchant and generates customized digital advertising campaigns based on the publicly-available information.

### CLAIM OF PRIORITY

This application claims priority to U.S. provisional application Ser. No. 62/676,310 filed on May 25, 2018 and also to U.S. provisional application Ser. No. 62/807,294, filed on Feb. 19, 2019, each incorporated herein in its entirety.

### BACKGROUND

### Field of Use

The present application relates to the field of digital marketing. More specifically, the present application relates to advanced digital marketing systems, apparatus and methods to automatically create and manage digital marketing campaigns for business owners.

### Description of the Related Art

Digital advertising has become prevalent along with the rise of social media. Such digital advertising includes banner ads, click-through ads, search engine optimization, pay-per-click advertising, social media advertising (i.e., placement of ads on Facebook, Instagram, Twitter, etc.), influencer marketing, email marketing, and other forms of marketing that is displayed on digital devices, such as smart phones, computers, digital signage and billboards, wearables and other electronic display devices.

The creation of such digital advertisements is typically a time-consuming and imprecise process. A business owner desiring to place digital advertisements must either hire an advertising agency to create ads based on information provided to the agency by the business owner. This process is both expensive and time-consuming, and often there is no feedback provided by the advertising agency as to how well a particular advertisement or series of advertisements (known as “advertising campaigns” or, simply, “campaigns”) performs.

Business owners may, alternatively, turn to online advertising tools offered by social media sites and independent web sites to create digital advertisements. For example, Ad Espresso is a Facebook Ads tool that offers ad creation and optimization. Since it was founded in 2011, it has grown to become a Facebook advertising partner and a popular marketing tool for brands all over the world. However, these online advertising tools also require substantial amounts of time to create new advertisements and typically have no way to determine whether a particular advertisement is effective or not.

Thus, it would be desirable to overcome the problems of the prior art, to provide an inexpensive and convenient way for business owners to place digital advertisements.

### SUMMARY

The embodiments described herein relate to advanced digital marketing systems, methods and apparatus. In one embodiment, a method is described, performed by a server, for creating digital advertising campaigns, comprising receiving, by a processor via a network interface coupled to the processor, business identification information from a merchant over a wide-area network, identifying, by the processor, one or more web servers comprising publicly-available information pertaining to the merchant, retrieving, by the processor via the network interface, the publicly-available information, and constructing, by the processor, an initial digital advertising campaign based on the publicly-available information.

In another embodiment, a computer server is described, for automated creation of digital advertising campaigns, comprising a network interface for sending and receiving data across a digital communication network, a memory for storing processor-executable instructions, and a processor, coupled to the network interface and the memory, for executing the processor-executable instructions that causes the server to receive, by the processor via the network interface, business identification information from a merchant over the wide-area network, retrieve, by the processor via the network interface, publicly-available information related to the merchant, and construct, by the processor, an initial digital advertising campaign based on the publicly-available information.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a semi-automated, digital advertising campaign system in accordance with the teachings herein;

FIG. 2 illustrates one embodiment of a functional block diagram of a server used in the advertising campaign system shown in FIG. 1;

FIGS. 3A-3D are a flow chart illustrating one embodiment of a method, performed by the server in FIGS. 1 and 2, for creating digital advertising campaigns; and

FIGS. 4A and 4B are a flow diagram illustrating one embodiment of a method performed by the server as shown in FIG. 1 for digital advertisement creation and scheduling in another embodiment of the invention.

### DETAILED DESCRIPTION

Embodiments of the present invention comprise systems, apparatus and methods for automatic generation of customized advertising campaigns based on publicly-available online data, such as from social media websites, merchant review websites, as well as from a merchant's online private accounts. The term “merchant”, as used herein, means a retail business and/or a business owner that sells goods and/or services to the general public, having either one or more “brick-and-mortar” retail locations, one or more sales web sites, or both. The term “campaign”, as used herein, refers to one or more digital advertisements that are placed on specific websites in coordination with each other to achieve a certain result, such as to drive engagement, conversions, traffic, or revenue to the merchant. Examples of marketing campaigns comprise a social status campaign, where advertisements are directed towards potential customers based on user statistics from one or more social media platforms, a holiday campaign, where advertising is targeted based on a particular local, state or national holiday, a sports campaign, where advertising is based on one or more particular sports, sporting events, sports teams, or individual players, marketing efforts tailored to boost in-store traffic, buy-one-get-one marketing, campaigns targeted to specific online websites, such as Facebook, YouTube, Instagram, etc. Typically, each campaign ties in with overarching goals of the merchant and includes one or more digital channels, such as search engines, social media, mobile, and the merchant's website, in the efforts. In the past, such marketing campaigns involved speaking with an advertisement agency to develop a marketing plan based on a selection of marketing content, channels of distribution and cost. Lacking was any meaningful feedback mechanism to determine how effective a particular content, or distribution channel, had performed. Finally, although this disclosure describes an embodiment of the invention in reference to a restaurant, it should be understood that the concepts described herein could be applied to other retail establishments, such as bars, clothing stores, automobile repair shops, airlines, plumbers, spa services, cleaning services, or just about any retail establishment that sells goods or services to the general public.

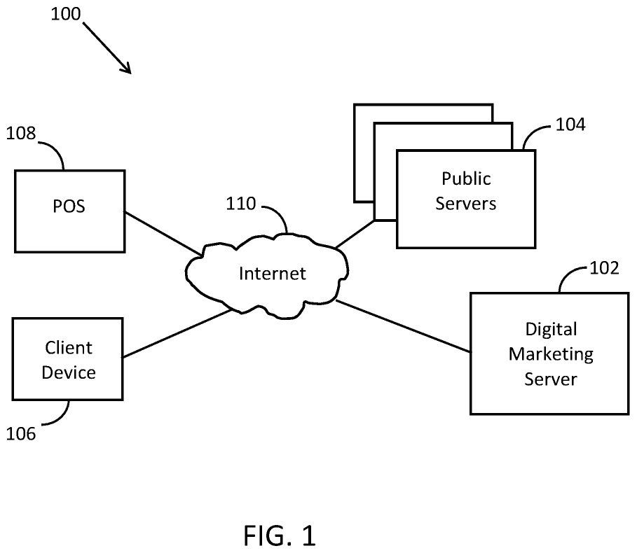

FIG. 1 illustrates one embodiment of a system 100 for automatic generation of customized advertising campaigns. Shown is digital marketing server 102 coupled to public servers 104, client device 106, point-of-sale (POS) system 108 via wide-area network 110. It should be understood that although only one client device and one POS system is shown in FIG. 1, in practice, many thousands of client devices and many thousands of POS systems may be coupled to server 102, and server 102 creates digital advertisements for businesses associated with each client device and/or POS system.

A merchant may use system 100 to automatically, or semi-automatically, generate digital marketing campaigns, tailored to help improve sales of the merchant's goods or services. The merchant provides basic information about the merchant to server 102, such as the merchant's name, address, website URL and, in response, server 102 retrieves publicly-available information from one or more public servers 104 and, in some embodiments, private information from the merchant's own online accounts, also hosted by one or more of the public servers 104. Server 102 analyzes the public/private information obtained from the public servers 104 to deduce certain facts, insights, or attributes, related to the merchant's business. For example, the merchant may provide the merchant's business name and website URL to server 102. In response, server 102 may automatically perform an online search using the business name, then navigate to one or more web sites that are provided in the search results. Such web sites may include Facebook, Instagram, review web sites such as Yelp, etc. Server 102 evaluates each of the web sites associated with the merchant, and determines one or more attributes based on the information contained on each web site. For example, server 102 may navigate to the merchant's Facebook page, and use existing machine learning algorithms to ingest the information provided on the merchant's Facebook page, and determine the type of business that the merchant is conducting (i.e., retail clothing, restaurant, hotel, etc.) as well as other attributes. For example, server 102 may determine that the merchant sells expensive wines, both at a brick-and-mortar retail store and online, and that the words “awesome service” and “friendly” appear more frequently than any other word or word combination, and also select a digital photograph of a bottle of wine that may be featured on the Facebook website, such as at the top of the page.

In one embodiment, server 102 may present the one or more attributes to the merchant for verification that the attributes accurately describe the merchant's business.

Next, server 102 may automatically generate an initial digital advertisement using the attributes. In one embodiment, server 102 selects an advertisement template from a plurality of advertisement templates stored in a database coupled to or within server 102. Each advertisement template may be stored in association with one or more campaign types, such as “buy-one-get-one free”, a holiday theme, a sporting theme, etc. Selection of a particular template will be explained in more detail later herein.

One a template is selected, server 102 may arrange one or more of the attributes into the template to form the initial digital advertisement.

Once formed, server 102 may provide the initial digital advertisement to the merchant via the merchant's client device 106, i.e., a mobile phone, tablet, or computer operated by the merchant, i.e., an owner, employee or some other authorized agent for approval from the merchant. In some embodiments, server 102 generates multiple versions of the initial digital advertisement, each one formatted in accordance with a particular website where it will be presented. If approval of the initial digital advertisement is given by the merchant, server 104 places the initial digital advertisement with one or more online websites, such as social media websites such as Facebook, Instagram, Twitter, or other, general web sites, such as Yahoo.com, MSN.com, etc. Of course, the merchant may modify the initial digital advertisement if the merchant believes that such modifications are necessary. Placement of the digital advertisement(s) may be scheduled by server 102 to occur at one or more predetermined days and times.

In one embodiment, server 102 may provide deduced facts, attributes, or insights, to the merchant via client device 106, either periodically, such as once per day, or upon the occurrence of a predetermined event, such as a change in sales volume greater than a predetermined threshold set by the merchant. The insights are determined by server 102 in response to analyzing public or private information found on the public web servers 104 over time. Server 102 presents one or more insights to client device 106, whereupon the merchant can verify if the insight is correct or is otherwise applicable to the merchant's business. For example, such insights could comprise a determination that the merchant sells a particular product or service, that a landmark nearby (such as a school, church, theater district) is relevant to sales, that certain days or times of the day are busier than others, an average age of a typical customer, a gender preference, etc.

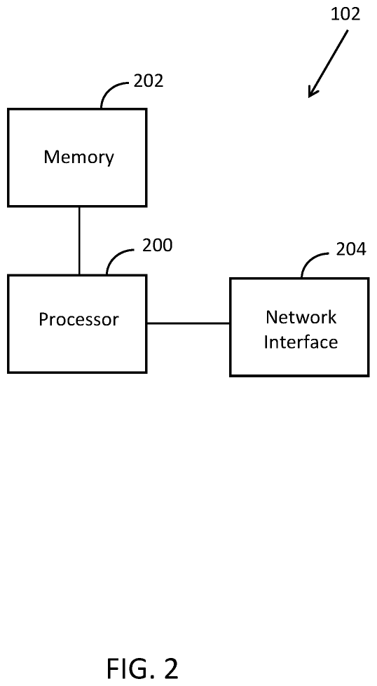

FIG. 2 illustrates a functional block diagram of one embodiment of digital marketing sever 102 comprising a cloud-based computer server. Specifically, FIG. 2 shows processor 200, memory 202, and network interface 204. It should be understood that the functional blocks shown in FIG. 2 may be connected to one another in a variety of ways, and that not all functional blocks necessary for operation of sever 102 are shown (such as a power supply) for purposes of clarity.

Processor 200 is configured to provide general operation of sever 102 by executing processor-executable instructions stored in memory 202, for example, executable code. Processor 200 typically comprises one or more microprocessors, microcontrollers, custom ASICs and/or related circuitry. The selection of processor 200 is generally based on computational speed, cost, size, power consumption, heat generation, among other factors.

Memory 202 is coupled to processor 200, comprising one or more non-transitory information storage devices, such as RAM, ROM, flash memory, or other type of non-volatile electronic, optical, or mechanical memory device. Memory 202 is used to store processor-executable instructions for operation of server 102 and, in some embodiments, a database of advertising templates, merchant information (such as an account number, name, address, email address, web site address of the merchant, and any information provided by the merchant to server 102 during interactions between the merchant and server 102, such as permissions, private account information of the merchant's business accounts with one or more public servers 104 (such as Facebook Business, Snap Ads, YouTube Ads, Google Ads, Square, Google My Business, etc.). In some embodiments, a portion of memory 202 may be embedded into processor 200 while another portion reside separately coupled to server 102, such as a hard drive. Finally, memory 202 excludes media for propagating signals.

Network interface 204 is coupled to processor 200, comprising circuitry necessary for processor 200 to communicate with the public servers 104, client device 106 and, in some embodiments, POS 108, typically over a local network such as WiFi or Ethernet and over wide-area network 110 using digital networking protocols well known in the art.

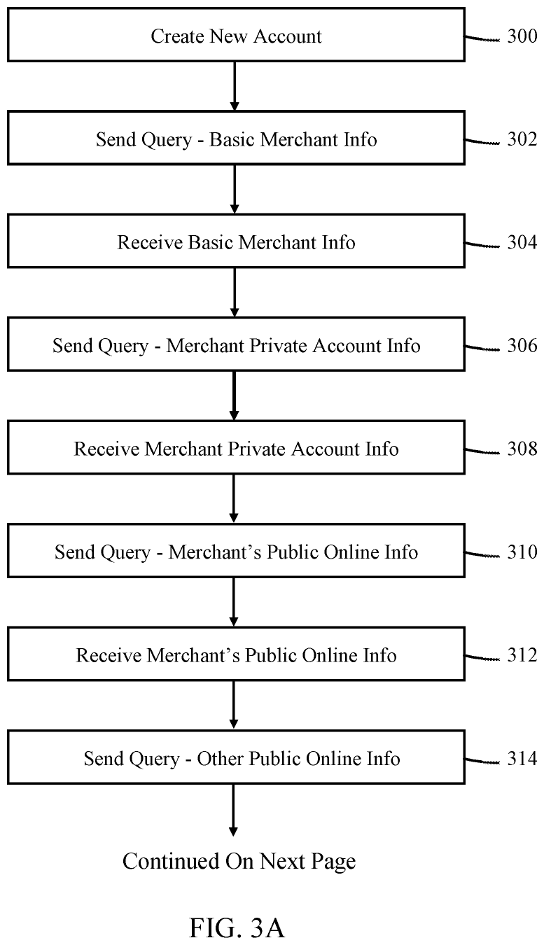

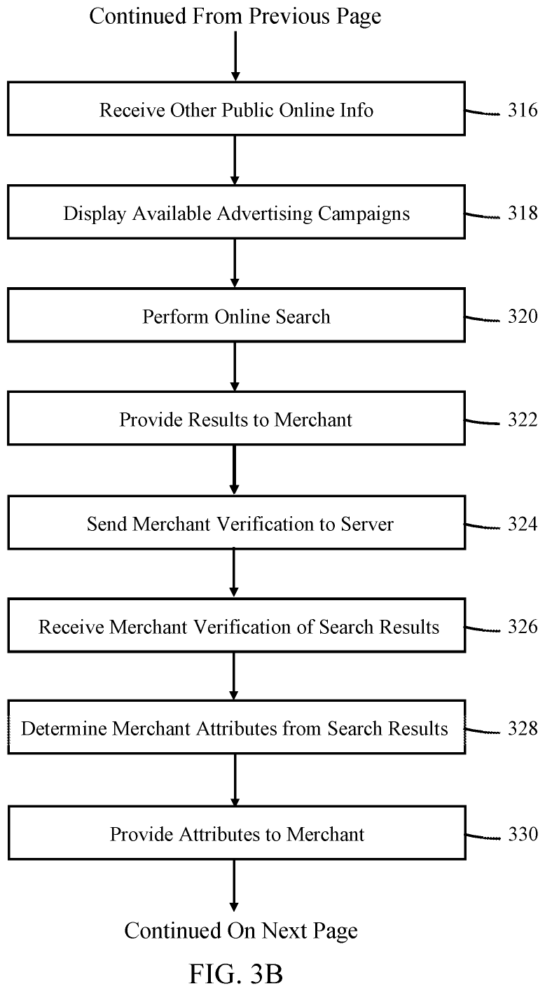

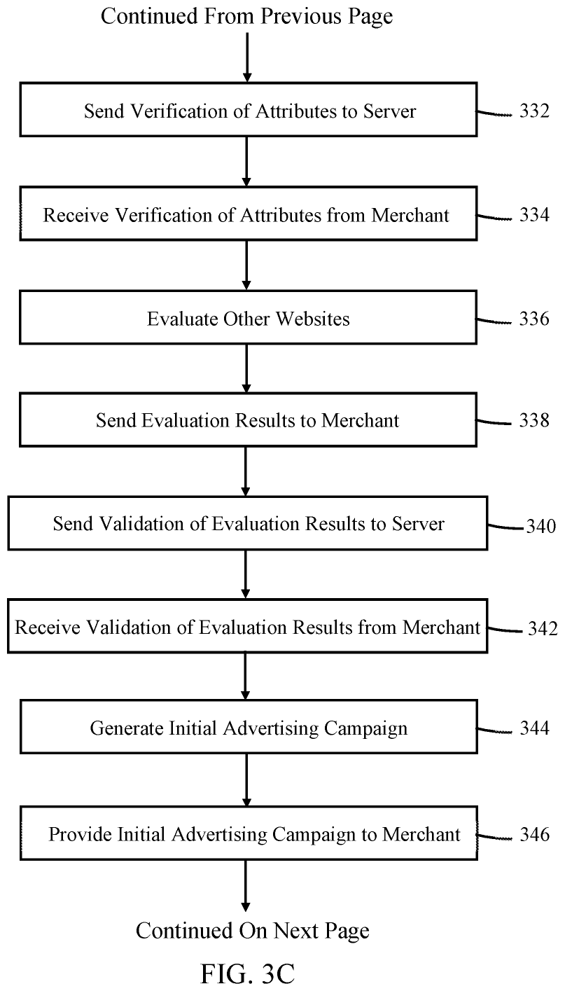

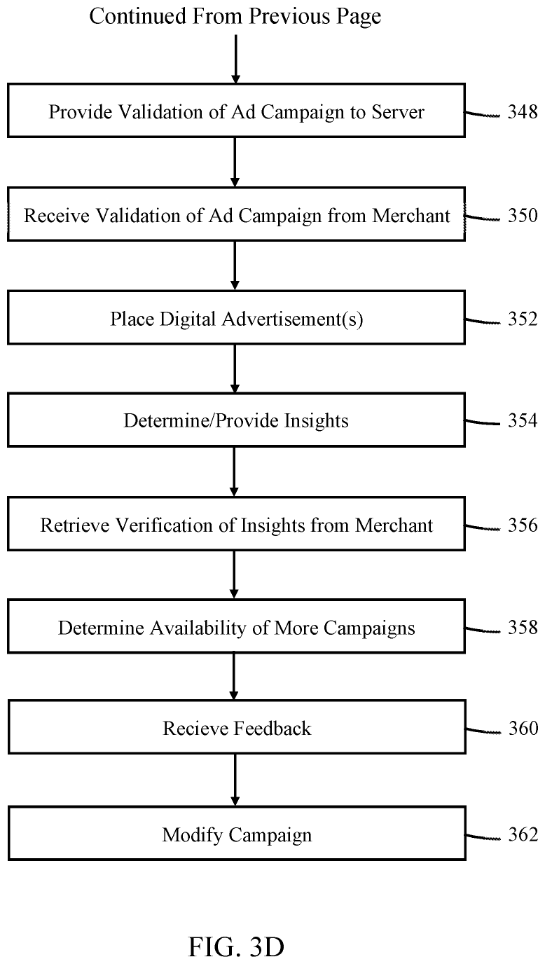

FIGS. 3A-3D are a flow diagram illustrating one embodiment of a method executed by server 102 for automatic generation of customized advertising campaigns. It should be understood that the steps described in this method could be performed in an order other than what is shown and discussed, and that minor steps have been omitted for clarity. It should also be understood that while the foregoing is described with respect to a single merchant, server 102, in practice, typically performs the method for numerous merchants simultaneously.

At block 300, a merchant, such as the owner or employee of a retail business offering goods and/or services to the general public may create an account with server 102 using client device 106, as generally known in the art, to automatically or semi-automatically create advertisements and/or advertising campaigns. The merchant creates the account using client device 106, which is in communication with server 102 via wide-area network 110. Client device 106 may execute a customized application or “app” that provides a convenient user interface for the merchant to interact with the server 102, also as well known in the art.

At block 302, either during or after the account creation process, processor 200 within server 102 causes server 102 to query the merchant, via network interface 204 and client device 106, to provide basic identification information pertaining to the merchant's business, if this information was not provided during the account creation process described above. The basic identification information may comprise a name, address, email address, physical location, and/or web site address of the merchant's business. The basic identification information may further comprise a desired cost, or cost limit, indicating a cost that the merchant is willing to accept to run an ad campaign.

At block 304, processor 200 receives, via network interface 204 the basic identification information from the merchant via network interface 204 and stores it in memory 202 in connection with the merchant's account.

At block 306, in one embodiment, processor 200 causes sever 102 to query the merchant, via network interface 204 and client device 106, to provide access to one or more of the merchant's existing advertisement-related websites, such as Facebook Business, Snap Ads, YouTube Ads, Google Ads, Square, or Google My Business. Such websites allow merchants to place digital advertisements, and sometimes provide usage statistics on behalf of merchants, such as search engine results, traffic information, advertisement click statistics, and other metrics related to online advertising that the merchant may have engaged with in the past. The query may comprise a graphical user interface comprising a list of such advertisement-related websites for the merchant to choose, a logo associated with each business-related website, or some other way for the merchant to indicate to processor 200 the identify of the merchant's advertisement-related websites to processor 200. In addition, the merchant provides login credentials for each of the websites in order for server 102 to access the merchant's accounts on each site.

At block 308, processor 200 receives, via network interface 204, the identify of the one or more advertisement-related websites and related credentials and stores this information in memory 202 in connection with the merchant's account.

At block 310, processor 200 may cause server 102 to query the merchant, via network interface 204 and client device 106, to provide an identification of the merchant's public websites, such as the merchant's social media sites, such as Facebook, Instagram, Twitter, Snapchat, Linkedin, etc.

At block 312, processor 200 receives the identifications of the public websites from the merchant via network interface 204 and stores this information in memory 202 in connection with the merchant's account.

At block 314, processor 200 may cause server 102 to query the merchant, via network interface 204 and client device 106, to provide web site identification information for other web sites related to the merchant's business, such as URLs to blogging sites, wikis, and podcasts that relate to the merchant's business.

At block 316, processor 200 receives the identifications of the other websites via network interface 204 and stores this information in memory 202 in connection with the merchant's account.

At block 318, in one embodiment, processor 200 causes client device 106 to present a listing of advertising campaigns available to the merchant, based on, in one embodiment, the quantity and/or type of information previously provided by the merchant to server 102. In one embodiment, one or more basic advertising campaigns are shown to be available to the merchant for the merchant to select as the basis for an advertising campaign. For example, a default advertising campaign may generate a simple digital advertisement comprising one digital photograph and one or two lines of advertisement copy and not tailored to any particular campaign type, such as a theme, holiday, sports, social status, in-store traffic, buy-one-get-one, social media, or other campaign type. These campaign types are generally unavailable to the merchant until the merchant has indicated, or server 102 has determined, attributes relevant to the merchant's business, such as whether the merchant's business caters to a particular sex, sport, sporting team, religion, good or service type, etc.

At block 320, in one embodiment, processor 200 may perform an Internet search to identify websites and related servers that pertain to the merchant's business (i.e., a review website that comprises a review of the merchant's business, the merchant's Facebook, Instagram, or Twitter webpages, a blog that mentions the merchant's business, etc.), using one or more search engines commonly available, such as Google, Yahoo, MSN, etc. Processor 200 searches key terms that may have been provided by the merchant in one or more of the blocks 302-316, above. For example, processor may search for the merchant's name and a city where the merchant's business is located. The search engine may provide a number of links to web pages related to the business. Processor 200 receives the links and retrieves data from one or more of the links in the form of text, digital photographs, and digital video using techniques well known in the art to automatically scan web pages and retrieve such data.

At block 322, processor 200 may provide at least some of the results of the search conducted at block 320 to the merchant via network interface 204 and client device 106, in order to confirm that the server 102 has correctly identified the merchant's business online. The results may be provided as text and/or graphical information about the merchant's business. For example, processor 200 may provide a link to the merchant's website, a physical address, phone number, and hours of operation, and a photo related to the merchant's business.

At block 324, the merchant verifies that the information is correct, and confirmation is sent by client device 106 to processor 200 via network interface 204.

At block 326, the confirmation is received by processor 200 via network interface 204.

At block, 328, processor 200 may access the web sites identified by the merchant at block 314, as well as websites that were discovered in the Internet search conducted at block 320, in order to determine attributes of the merchant's business, such as types of goods and services sold by the business, prices associated with the goods or services, demographics of actual customers (i.e., sex, age, etc.), atmosphere (i.e., fine dining, casual, outdoor dining, kid friendly), customer ratings, photos related to the merchant's goods or services, and key words used by customers to describe the business (i.e., “great service”, “great value”, “friendly”). For example, server 102 may access yelp.com to search for reviews from previous customer interactions with the merchant's business and select key words that occur often and, in this example, determine that “Italian food”, “good for kids” and “causal” are three phrases that are found most often in one or more of the websites evaluated by processor 200. Processor 200 may evaluate a plurality of digital photographs on the public websites 104 and determine that a particular item is shown most often, then select one or more of the photographs that shows the first item.

At block 330, processor 200 provides the results of the determination in block 328 to the merchant via network interface 204 and client device 106.

At block 332, the merchant verifies that the determination is correct, and confirmation is sent by client device 106 to processor 200 via network interface 204.

At block 334, the confirmation is received by processor 200 via network interface 204.

At block 336, processor 200 may evaluate additional websites, based on the confirmation that was received at block 334, or further evaluate the information already gathered from block 328. For example, processor 200 may determine three of the most popular products or services offered by the merchant, again based on the initial or additional website evaluation, in this case, pepperoni pizza, garlic bread and manicotti. Processor 200 may additionally identify photographs of these items found on the evaluated web sites.

In one embodiment, if no photos of such items are found on the evaluated websites, processor 200 may conduct an additional online search for photographs of one or more of the items or, in another embodiment, search a database of stock photographs maintained in memory 202 by server 102.

At block 338, processor 200 provides the results of the additional evaluation of the merchant via network interface 204 and client device 106.

At block 340, the merchant verifies that the additional evaluation is correct, and confirmation is sent by client device 106 to processor 200 via network interface 204.

At block 342, the confirmation is received by processor 200 via network interface 204.

At block 344, processor 200 may generate an initial advertising campaign, based on the information provided by the merchant and the website evaluations. An ad campaign generally refers to one or more digital advertisements that are placed a number of times on one or more websites in order to achieve a particular purpose, such as to increase sales, increate page clicks, or increase page views. As an example, the ad campaign may seek to increase overall sales of an Italian restaurant, comprising four digital ads, each ad formatted in accordance with a particular website where the ad will be placed. Processor 200 may generate the ad campaign based on a cost to place each of the ads for a predetermined number of times a certain time period. The merchant may provide a target cost for each ad campaign to processor 200, as mentioned at block 302. Processor 200 may use the cost information to determine the number of ads created, number of times each ad may be displayed, time periods of ad display, and identities of social media or other websites on which to display the ads. The term “initial” is used here to denote a first iteration of the ad campaign, as processor 200 modify the initial campaign, as described later herein.

The number and type of advertisements is provided by server 102 based on techniques such as artificial intelligence, i.e., learning, by server 102, which type of advertisements work best with particular kinds of businesses, their customers, geographical information, particular goods and services, and many other factors. This information may be gathered by server 102 over time, receiving feedback based on things like clicks on advertisements, “Likes” on Facebook, or some other digital feedback that can alert server 102 that a customer or potential customer has shown interest in an advertisement.

In one example, processor 200 generates the initial campaign by creating a first ad comprising a digital photograph of pasta, some descriptive text of the pasta and a link to the merchant's webpage and formats the first ad for placement by Facebook in each user's news feed within 50 miles of the merchant's business location, in this case an Italian restaurant. Processor 200 creates a second ad comprising a different photograph of pasta, with different descriptive text and a link to the merchant's webpage and formats the second ad for placement by Instagram on each user's Instagram page, also within 50 miles of the restaurant. Processor 200 creates a third ad comprising key words for posting on Google Ad Words, and a fourth ad comprising the same photograph of pasta as in the second ad, with different descriptive text and a link to the merchant's webpage and formats the fourth ad for placement for placement on digital signage, such as on an indoor or outdoor digital billboard.

In one embodiment, advertising “templates” are stored in a database inside memory 202 and used by processor 200 to create ads. Each template comprises a pre-designed advertisement, comprising ad copy and/or one or more spaces for insertion of digital photographs selected by processor 200 during the creation of each ad. For example, a first ad template may comprise a space to insert a digital photograph with the words “You've Tried the Rest, Now Try the Best! ______ Italian restaurant. Visit our Website at www.______.com”. Processor 200 may select this template when the evaluation of public websites indicates that a business is an Italian restaurant. Processor 200 creates an ad by inserting a digital photograph found by processor 200 during evaluation of the public websites into the reserved space in the ad, inserts the name of the Italian Restaurant into the space before “Italian restaurant”, and inserts the restaurant's URL into the space designated for a website address. Of course, a wide variety of templates can be pre-designed and stored in memory 202 to accommodate a wide variety of business types, target demographics, holidays, sporting events/teams, etc. In each case, processor 200 identifies a template using the evaluations of the public websites. Each template is stored in the database in memory 202 and identified by one or more template attributes.

At block 346, processor provides the ad campaign to the merchant via network interface 204 and client device 106 for approval. The ad campaign may comprise the ad(s) created at block 344, plus additional information that was used by processor 200 to create the ad(s). For example, processor 200 may list the target demographic age, sex, political persuasion, and distance from the business, suggested ad run days and times, the amount each ad and/or the campaign will cost (using the suggested number of ads, website selection, days, times and duration of the ads), etc. For example, a Facebook ad as part of the campaign may also list that the ad is targeted to Men over 35 and Women over 30, and should run from 11 am-4 pm, Monday-Friday The cost of each ad or the entire campaign may be modified by the merchant in one embodiment, by using a “slider” in the display of client device 106 which adjusts the cost of each ad or the entire ad campaign. Processor 200 receives this information and adjusts the number of ads, website selection, days, times duration of the ads, etc. in order to meet the merchant's desired cost, and causes the new ad campaign to be displayed to the merchant on client device 106. In some embodiments, the merchant is able to edit the additional information, such as the target market, the days and times when to run the ad, number of ads, websites where the ads will be placed manually. The edited information is provided to processor 102 via network interface 204, and processor 102 causes a new ad campaign to be displayed to the merchant in accordance with the merchant's desires.

At block 348, when the merchant is satisfied with the ad campaign, the merchant provides an indication to processor 102 via client device 106 and network interface 204.

At block 350, processor 200 receives the approval of the ad campaign from the merchant.

At block 352, processor 200 places each of the ads onto a respective merchant advertising website, using the information provided by the merchant at block 306. Processor 200 utilizes respective computer APIs to provide each ad to its respective advertising website along with the additional information, such as when and how long to run each ad.

At block 354, either before or after placement of an ad campaign, processor 200 may provide one or more insights to the merchant via network interface 204 and client device 106, either periodically, such as once per day, or upon the occurrence of a predetermined event, such as a change in an aspect of the merchant's business, such as a change in sales volume, clicks, page views, etc. The insights may be determined by server 102 in response to analyzing public information found on the public web servers 104 over time (such as user reviews and comments, updated menu items, photographs, new business hours, or a new location posted by the merchant (or others)), or they may be pre-stored in memory 202 and provided to the merchant randomly by processor 200. Processor 200 presents these insights to the merchant, whereupon the merchant can verify if the insight is correct or is otherwise applicable to the merchant's business. For example, one insight could comprise a determination that the merchant sells a particular product or service, that a landmark nearby (such as a school, church, theater district) is relevant to sales, that certain days or times of the day are busier than others, an average age of a typical customer, a gender preference, etc. Other insights may not be solely based on publicly-available data. Rather, these insights could comprise queries that may generally apply to a wide variety of businesses, such as “Your Sales Are Affected by Weather” or “Your Busiest Hours Are After 6 pm”. In either case, the insights are provided by processor 200 to client device 106 via network interface 204, where the merchant may verify if the insight is correct.

Additional examples of insights could comprise “Mothers love your brand and location!”, “People miss your Garlic Fries”, “62% of Your Likes are Based on Your Daily Specials”, and “Your Baked Chicken Dinner is not Popular” based on server 102 determining this information by analyzing public comments and reviews from one or more review sites, the merchant's social media webpage(s), other websites that show up in an Internet search conducted by processor 200, etc. Other insights, such as “You Could Be Busier at Lunch Times” may be generated by server 102 as a result of processor 200 analyzing purchasing information via a merchant's POS system, or “Comic Con is a Major Event in your Area” upon server 102 determining major events that occur within a predetermined distance from the merchant's location.

At block 356, processor 200 receives verification from the merchant whether the insight was applicable or not. Processor 200 may modify one or more active campaigns based on whether the merchant verified the insight or not. For example, if the merchant indicated that weather is a factor in sales (i.e., when it is cold and rainy, sales decrease), then processor 200 may create a new ad by identifying a new template from memory 202 that is tailored to increase sales during inclement weather, such as a template comprising ad copy that says, “20% Off When It's Below Freezing Outside!”. Processor 200 may modify the overall campaign by replacing one of the ads in the campaign with the new ad or add the new ad to the existing ads in the campaign after providing the new ad and/or campaign to the merchant for approval. Processor 200 then places the new ad on one or more websites, as described earlier herein.

In one embodiment, processor 200 may limit the number of campaign types available to a merchant until the merchant provides processor 200 with certain information that is pertinent to a particular advertising campaign. For example, a “Social Status” campaign may be “unlocked” or made available by processor 200 when the merchant provides the merchant's account information for two or more social media websites. A “National Holidays” campaign is made available by processor 200 when the merchant provides the merchant's Google Ads account information. This campaign creates ads based on particular national holidays, and processor 200 suggests placement of such ads prior to pertinent holiday periods. A “Sports Fanatic” campaign may be made available to the merchant when the merchant provides the name of a particular sport or sporting team name that the merchant's customers support. For example, processor 200 may generate a Facebook advertisement featuring a photo of the Green Bay Packers, with suggested advertisement run times (based on a determination, by processor 200, of dates and times when the Packers will be playing in the future) before and during games played by the Packers. A “High Margin” campaign may be made available to the merchant when the merchant provides access to the merchant's POS system 108. In this campaign, processor 200 receives sales information from the merchant's POS system 108 to create even more targeted ad campaigns. The POS information can be used to determine trends, such as slow sales periods, and create ads to boost sales and traffic during these times. A “Geography” campaign may be used if the merchant provides landmark information to processor 200 that tend to drive traffic. For example, the merchant can provide the name of a church nearby the merchant's business. In response, processor 200 may perform an Internet search for the name of the church nearby the merchant's business, and then access the church's website to determine what time services are performed. Processor 200 may then create a geography campaign comprising advertisements based on the name of the church and place the advertisements at strategic times on social media, or on the churches blog or website, such as a photo of the church, the name of the merchant's business, a map on how to get to the merchant's business, and a discounted price on goods or services (i.e., “Half Off After Services on Sundays!).

At block 358, processor 200 determines that a merchant has provided information to unlock one or more additional campaigns and notifies the merchant via network interface 204 and client device 106. Thereafter, the merchant may choose one of the available campaigns available to the merchant, and processor 200 may generate an ad campaign based on the user's selection, as well as the publicly-available information from the public servers 104.

At block 360, in one embodiment, after an ad campaign has been provided to one or more web sites, processor 200 may receive feedback from such web sites, other web sites, or the merchant's POS system 108 to indicate sales, traffic, clicks, page views, or some other feedback to indicate one or more aspects of the merchant's business. Having access to a merchant's POS information can allow processor 200 to determine which products are most/least popular, what days/times are customers most likely to purchase particular goods/services, and how sales are affected by the advertisements placed by processor 200. For example, if processor 200 places a particular Facebook ad every day, and then runs a different ad on Facebook every day, processor 200 can determine the sales during a time period associated with each ad. Processor 200 may then determine that the first ad resulted in much better sales than the first advertisement, and processor 200 can automatically change the second ad to more closely resemble the first ad, and then track the sales results to determine if the resulting sales increases as expected. This is just one example of how processor 200 can examine results from a POS system to automatically generate or modify advertisements and campaigns, for example, by selecting/changing a composition of an advertisement (i.e., whether the advertisement should be in the form of a photo, text, video, etc.), a “tone” (i.e., happy, funny, serious, etc.), a run frequency (i.e., how often the advertisement is run), a time of day that the ad is run, various platforms that the ad is offered, etc.).

At block 362, processor 200 may modify a published ad campaign (i.e., an ad campaign that is actively being presented to the general public online) based on the feedback received at block 360. In one embodiment, processor 200 provides the modified ad and/or campaign to the merchant to validate the change. If the merchant approves the change, then processor 200 places the new advertisement in accordance with the campaign.

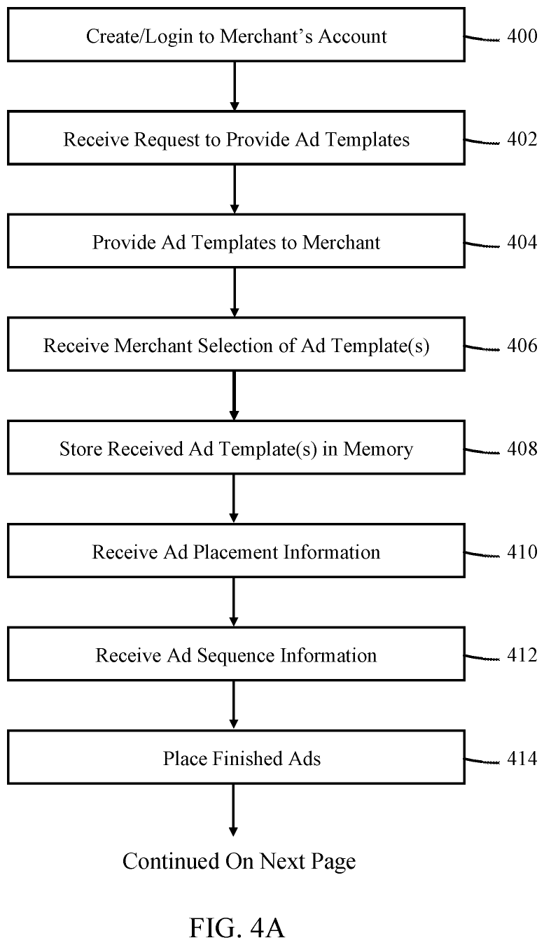

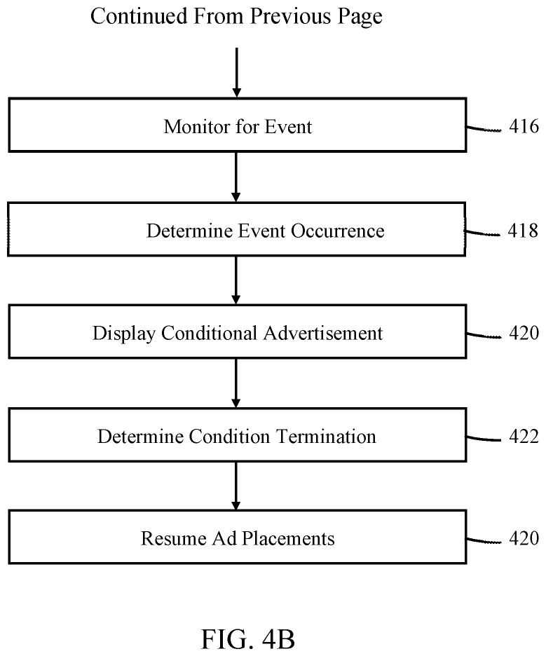

FIGS. 4A and 4B are a flow diagram illustrating one embodiment of a method performed by server 102 for digital advertisement creation and scheduling in another embodiment of the invention. In this embodiment, a merchant may create a series of digital advertisements based on a number of templates or “cards” stored in memory 202, and then schedule the ads in each ad campaign in a dynamic fashion, which will be explained below. It should be understood that the steps described in this method could be performed in an order other than what is shown and discussed, and that minor steps have been omitted for clarity.

At block 400, a merchant may create or log into an account maintained by server 102 via client device 106 executing an app that allows interaction between the merchant and server 102 for creating and scheduling digital advertisements.

At block 402, processor 200 in server 102 receives a request from the merchant, via network interface 204, to provide an indication of one or more advertising templates stored in memory 202. The request may cause processor 200 to provide indications of all, or a portion of, the templates stored in memory 202. The indications may comprise a title of each template and/or a photo/video and/or ad copy of what a digital advertisement would look as generated from each template, i.e., a photograph and some advertising copy. The ad copy may comprise generic ad copy with “blanks” to personalize the ad copy to the merchant. For example, the generic ad copy could comprise “Happy Hour at ______'s—Good Times!”, where the merchant's name is inserted into the blank by processor 200 to create a digital advertisement for the merchant. The request from the merchant may comprise an indication of a type or category of advertisement template the merchant is interested in, such as templates designed to sell more goods or services, templates designed to generate more foot traffic, templates designed to increate clicks or views, templates that may be based on conditional logic, such as templates that are based on weather, traffic, sporting events, IoT sensor data, POS data (such as inventory levels, sales volume), etc.

At block 404, processor 102 provides one or more indications of the advertising templates to the merchant via network interface 204.

At block 406, processor 200 receives an indication from the merchant, via network interface 204, of a selection of one or more of the templates and, in one embodiment, merchant data to be used for each template selected by the merchant. For example, processor 200 may receive an indication from the merchant that the merchant wishes to create three digital advertisements to be displayed in a particular order, each one related to increasing sales, and a fourth, conditional template, designed to keep customers from leaving the merchant's retail establishment(s) when a certain condition is achieved. For each template, the merchant provides information for customizing each digital ad to the merchant's business, for example, the name of the merchant's retail establishment, a physical address, a website address, a telephone number, an email address, a description or photograph/video of one or more particular goods or services (i.e., menu items, clothing items, spa services, etc.), etc. In one embodiment, processor 200 receives modified versions of each ad template that includes one or more of the above informational items provided by the merchant, where each modified version comprises a completed digital advertisement. In another embodiment, processor 200 provides one or more queries to the merchant to ask the merchant to provide the merchant information associated with each blank space in each ad template. For example, if the merchant selected a particular ad template that comprises ad copy and a first blank representing the merchant's business name, a second blank for representing an address of the merchant's retail store, and a third blank for representing a photograph of a particular menu item, processor 200 may query the merchant to provide the merchant's name, address and a photo/video of a particular menu item to server 102, and processor 200 inserts this information into the blanks to create the finished digital advertisement. The finished digital advertisements are then stored in memory 202 in association with the merchant.

Regarding conditional ad templates, processor 200 receives conditional information from the merchant in association with the selected conditional ad template. For example, the conditional ad template may comprise a simple banner ad that says “______% off of ______ when ______”. In this example, the conditional information comprises a percentage discount that the merchant is willing to give, a good or service that the merchant is discounting, and an event that triggers placement of the digital advertisement by processor 200, such as when “it is raining” or when “inventory of apples is greater than 100, or when “the San Diego Padres win a game”, etc.

An additional class of ad templates may also be defined, referenced herein as HTML visualization templates, where html code may be placed, in order to provide for dynamic content in a digital advertisement. For example, an HTML visualization template may be defined that shows the number of burgers ordered at a particular restaurant chain over time against a background of the restaurant's logo. The HTML code may cause a graph to be rendered within the advertisement, showing the number of burgers ordered over time. Thus, the HTML code can present data much more visually appealing to consumers.

At block 408, processor 200 stores one or more finished digital advertisements in memory in association with the merchant.

At block 410, processor 200 receives an indication from the merchant, via network interface 204, of one or more websites or digital billboards the merchant would like to place one or more of the finished digital advertisements, such as Facebook, Instagram, Twitter, or an electronic address of a digital billboard. Processor 200 stores this information in memory 202 in association with the merchant and, in some embodiments, each website in association with one or more particular finished digital advertisements as indicated by the merchant.

At block 412, processor 200 may receive an order, or sequence, for processor 200 to display the finished digital advertisements on one or more of the web sites previously indicated by the merchant. The order may be based on a ranking assigned to each finished digital advertisement by the merchant, where a plurality of digital advertisements are displayed in an order based on the ranking.

At block 414, processor 200 places the finished digital advertisements with one or more websites and/or digital billboards in an order as indicated by the merchant.

At block 416, processor 200 begins monitoring for a particular external event to occur in association with the particular conditional ad template chosen by the merchant. For example, the merchant may have chosen a conditional ad template based on weather. In this case, processor 200 determines a location of the merchant's business, typically by retrieving the address from the merchant's account as stored in memory 202, then initiates an action to receive weather information in an area encompassing the merchant's location from a weather server via network interface 204 and wide-area network 110.

At block 418, processor 200 receives a notification from the weather server (or other source in accordance with the type of conditional information that in the merchant's conditional advertisement, such as the merchant's POS server, a sports web server, a traffic web server, etc.) that it is raining in the location of the merchant's business (or, in another embodiment, processor 200 determines this from the information provided by the weather server).

At block 420, processor 200 places the conditional advertisement to one or more websites for display to users. In one embodiment, processor 200 interrupts one or more of the merchant's digital advertisements from being displayed by replacing the other digital advertisement with the conditional advertisement.

At block 422, processor 200 determines that the condition is no longer present, such as determining that a weather event is no longer occurring, or that there is no more traffic in an area near the merchant's business.

At block 424, processor 200 causes the conditional advertisement to be replaced by one of the other digital advertisements, in one embodiment, in accordance with the order of advertisement placements previously defined by the merchant, thus resuming the sequence of advertisement display.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different components, algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk, flash memory, etc., or communicated over a computer network wherein the program instructions are sent over optical or electronic communication links.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

We claim:

1. A method performed by a server for creating digital advertising campaigns, comprising:
receiving, by a processor via a network interface coupled to the processor, business identification information from a merchant over a wide-area network;
identifying, by the processor, one or more web servers comprising publicly-available information pertaining to the merchant;
retrieving, by the processor via the network interface, the publicly-available information; and
constructing, by the processor, an initial digital advertising campaign based on the publicly-available information.

2. The method of claim 1, wherein the publicly-available information comprises a plurality of photographs of items sold by the merchant posted to a public website, and constructing the initial digital advertising campaign comprises:
identifying, by the processor, an item in each of the plurality of photographs;
selecting, by the processor, a first item based on a number of times the first item is identified in the plurality of photographs; and
inserting, by the processor, a first photograph of the first item into a first advertisement of the initial digital advertising campaign.

3. The method of claim 1, wherein the publicly-available information comprises a plurality of textual reviews of the merchant's business posted to a public website, and constructing the initial digital advertising campaign comprises:
determining, by the processor, an occurrence of words or phrases in the plurality of textual reviews;
selecting, by the processor, a first word or first phrase based on the occurrence of the words or phrases in the plurality of textual reviews;
selecting, by the processor via a database stored in a memory coupled to the processor, an advertisement template from a plurality of advertisement templates based on the first word or first phrase; and
inserting, by the processor, the first word or first phrase into the advertisement template.

4. The method of claim 1, further comprising:
determining, by the processor, an attribute of the merchant's business based on the publicly-available information;
providing, by the processor via the network interface, a query to the merchant to confirm that the attribute is correct; and
receiving, by the processor via the network interface, a response to the query;
wherein constructing the initial digital advertising campaign comprises selecting, by the processor via a database stored in a memory coupled to the processor, an advertisement template from a plurality of advertisement templates based on the attribute.

5. The method of claim 1, further comprising:
determining, by the processor, an attribute of the merchant's business based on the publicly-available information;
providing, by the processor via the network interface, a query to the merchant to confirm that the attribute is correct;
receiving, by the processor via the network interface, a response to the query; and
modifying the initial digital advertising campaign based on the attribute.

6. The method of claim 4 wherein the attribute comprises a business type of the merchant's business.

7. The method of claim 1, wherein the initial digital advertising campaign comprises a first digital advertisement and a second digital advertisement, the method further comprising:
formatting, by the processor, the first digital advertisement in accordance with a first social media website format; and
formatting, by the processor, the second digital advertisement in accordance with a second social media website format.

8. The method of claim 1, wherein the initial digital advertising campaign comprises a first digital advertisement, the method further comprising:
providing, by the processor via the network interface, the first digital advertisement to a social media web server;
after providing the first digital advertisement to the social media web server, receiving, by the processor via the network interface, point-of-sale (POS) information from a POS system associated with the merchant;
determining, by the processor, via the POS information, that sales of goods or services offered by the merchant decreased after providing the first digital advertisement to the social media web server; and
altering, by the processor, the first digital advertisement when the sales of goods or services offered by the merchant decreased after providing the first digital advertisement to the social media web server.

9. The method of claim 1, further comprising:
determining, by the processor, an attribute of the business from the publicly-available information; and
as a result of determining the attribute, generating, by the processor, a second digital advertising campaign based on the attribute.

10. The method of claim 9, wherein the second digital advertising campaign comprises a second digital advertisement, and wherein the attribute comprises a name of a sports team, the method further comprising:
determining, by the processor, a time when a game will be played by the sports team; and
causing, by the processor via the network interface, the second digital advertisement to be displayed by a social media website prior to the time when the game will be played.

11. A server for automated creation of digital advertising campaigns, comprising:
a network interface for sending and receiving data across a digital communication network;
a memory for storing processor-executable instructions; and
a processor, coupled to the network interface and the memory, for executing the processor-executable instructions that causes the server to:
receive, by the processor via the network interface, business identification information from a merchant over the wide-area network;
retrieve, by the processor via the network interface, publicly-available information related to the merchant; and
construct, by the processor, an initial digital advertising campaign based on the publicly-available information.

12. The server of claim 11, wherein the publicly-available information comprises a plurality of photographs of items sold by the merchant posted to a public web page, wherein the instructions that causes the server to construct the initial digital advertising campaign comprises instructions that causes the server to:
identify an item in each of the plurality of photographs;
select a first item based on a number of times the first item is identified in the plurality of photographs; and
insert a first photograph of the first item into the initial digital advertising campaign.

13. The server of claim 11, wherein the publicly-available information comprises a plurality of textual reviews of the merchant's business posted to a public web page, wherein the instructions that causes the server to construct the initial digital advertising campaign comprises instructions that causes the server to:
determine, by the processor, an occurrence of words or phrases in the plurality of textual reviews;
select, by the processor, a first word or first phrase based on the occurrence of the words or phrases in the plurality of textual reviews;
select, by the processor via a database stored in the memory, an advertisement template from a plurality of advertisement templates based on the first word or first phrase; and
inserting, by the processor, the first word or first phrase into the advertisement template.

14. The server of claim 11, wherein the processor-executable instructions further comprise instructions that causes the server to:
determine, by the processor, an attribute of the merchant's business based on the publicly-available information;
provide, by the processor via the network interface, a query to the merchant to confirm that the attribute is correct; and
receive, by the processor via the network interface, a response to the query;
wherein the instructions that cause the server to construct the initial digital advertising campaign comprises instructions that causes the server to:
select, by the processor via a database stored in the memory, an advertisement template from a plurality of advertisement templates based on the attribute.

15. The server of claim 11, wherein the processor-executable instructions further comprise instructions that causes the server to:
determine, by the processor, an attribute of the merchant's business based on the publicly-available information;
provide, by the processor via the network interface, a query to the merchant to confirm that the attribute is correct;
receive, by the processor via the network interface, a response to the query; and
modify the initial digital advertising campaign based on the attribute.

16. The server of claim 14 wherein the attribute comprises a business type of the merchant's business.

17. The server of claim 11, wherein the initial digital advertising campaign comprises a first digital advertisement and a second digital advertisement, wherein the processor-executable instructions further comprise instructions that causes the server to:
format, by the processor, the first digital advertisement in accordance with a first social media website format; and
format, by the processor, the second digital advertisement in accordance with a second social media website format.

18. The server of claim 11, wherein the initial digital advertising campaign comprises a first digital advertisement, and wherein the processor-executable instructions further comprise instructions that causes the server to:
provide, by the processor via the network interface, the first digital advertisement to a social media web server;
after providing the first digital advertisement to the social media web server, receive, by the processor via the network interface, point-of-sale (POS) information from a POS system associated with the merchant;
determine, by the processor, via the POS information, that sales of goods or services offered by the merchant decreased after providing the first digital advertisement to the social media web server; and
alter, by the processor, the first digital advertisement when the sales of goods or services offered by the merchant decreased after providing the first digital advertisement to the social media web server.

19. The server of claim 11, wherein the processor-executable instructions further comprise instructions that causes the server to:
determine, by the processor, an attribute of the business from the publicly-available information; and
as a result of determining the attribute, generate, by the processor, a second digital advertising campaign based on the attribute.

20. The server of claim 19, wherein the attribute comprises a name of a sports team and the second digital advertising campaign comprises a second digital advertisement, wherein the processor-executable instructions further comprise instructions that causes the server to:
determine, by the processor via the network interface, a time when a game will be played by the sports team; and
cause, by the processor via the network interface, the second digital advertisement to be displayed by a social media website prior to the time when the game will be played.
